(19) United States
(12) Patent Application Publication
(10) Pub. No.: US 2003/0048596 A1
(43) Pub. Date: Mar. 13, 2003

(54) Foldable keyboard with parallel linkages

(75) Inventors: Owen Hsieh, Taipei City (TW); Chun-Kuan Lin, Taipei City (TW)

Correspondence Address: MORGAN LEWIS & BOCKIUS LLP, 1111 PENNSYLVANIA AVENUE NW, WASHINGTON, DC, 20004, US

(73) Assignee: Huey-Shiang Yen

(21) Appl. No.: 10/236,922

(22) Filed: Sep. 9, 2002

(30) Foreign Application Priority Data
Sep. 10, 2001 (TW) 090215522

(51) Int. Cl. G06F 1/16

(52) U.S. Cl. 361/680; 400/82

(57) ABSTRACT

A foldable keyboard includes a keyboard body and a linkage unit. The keyboard body includes a central section and left and right sections respectively disposed at left and right sides of the central section. The linkage unit includes two opposing pairs of first parallel linkages that are respectively pivoted to front and rear sides of the left and central sections, and two opposing pairs of second parallel linkages that are respectively pivoted to the front and rear sides of the right and central sections so as to permit folding of the keyboard body.

### CROSS-REFERENCE TO RELATED APPLICATION

This application claims priority of Taiwanese Application No. 090215522, filed on Sep. 10, 2001.

### BACKGROUND OF THE INVENTION

1. Field of the Invention

This invention relates to a foldable keyboard with pairs of parallel linkages.

2. Description of the Related Art

FIGS. 1 and 2 illustrate a conventional foldable keyboard 1 that are divided into first, second, third, and fourth sections 11, 12, 13, 14 which are aligned in the above order. The second and third sections 12, 13 are pivoted to each other through a first hinge 96. The first and second sections 11, 12 are pivoted to each other through a second hinge 97. The third and fourth sections 13, 14 are pivoted to each other through a third hinge 98. Each of the second and third hinges 97, 98 has a width (W) that is substantially equal to twice the thickness of the keyboard 1 in order to permit the first and second sections 11, 12 and the third and fourth sections 13, 14 to evenly overlap with each other. To avoid formation of undesired spaces between the first and second sections 11, 12 and between the third and fourth sections 13, 14 by virtue of the lengths of the second and third hinges 97, 98 when the keyboard 1 is disposed at an extended position, the first and fourth sections 11, 14 are constructed to be movable relative to the second and third sections 12, 13. As a consequence, the structure of the conventional foldable keyboard 1 is complicated and incurs higher manufacturing costs.

### SUMMARY OF THE INVENTION

Therefore, it is an object of the present invention to provide a foldable keyboard that is capable of overcoming the aforesaid drawback.

According to the present invention, there is provided a foldable keyboard that comprises: a keyboard body including a central section with opposite left and right sides and opposite front and rear sides, and left and right sections respectively disposed at the left and right sides of the central section, each of the left and right sections having front and rear sides; and a linkage unit including two opposing pairs of first parallel linkages that are respectively pivoted to the front and rear sides of the left and central sections adjacent to the left side of the central section, and two opposing pairs of second parallel linkages that are respectively pivoted to the front and rear sides of the right and central sections adjacent to the right side of the central section so as to permit folding of the keyboard body.

### BRIEF DESCRIPTION OF THE DRAWINGS

In drawings which illustrate embodiments of the invention,

FIG. 1 is a schematic view showing a conventional foldable keyboard when disposed at an extended position;

FIG. 2 is a schematic view showing how the foldable keyboard of FIG. 1 is folded;

FIG. 3 is a perspective view showing a first preferred embodiment of a foldable keyboard according to this invention when disposed at a folded position;

FIG. 4 is a schematic view showing the foldable keyboard of FIG. 3 when disposed at an extended position;

FIGS. 5 to 7 are schematic views illustrating consecutive steps for moving the foldable keyboard of FIG. 3 from the extended position to the folded position;

FIG. 8 is a schematic sectional view illustrating a cover of the foldable keyboard of FIG. 3 when disposed at a covering position;

FIG. 9 is a schematic sectional view illustrating the cover of FIG. 8 when disposed at an uncovering position; and

FIG. 10 is a perspective view showing a second preferred embodiment of the foldable keyboard according to this invention.

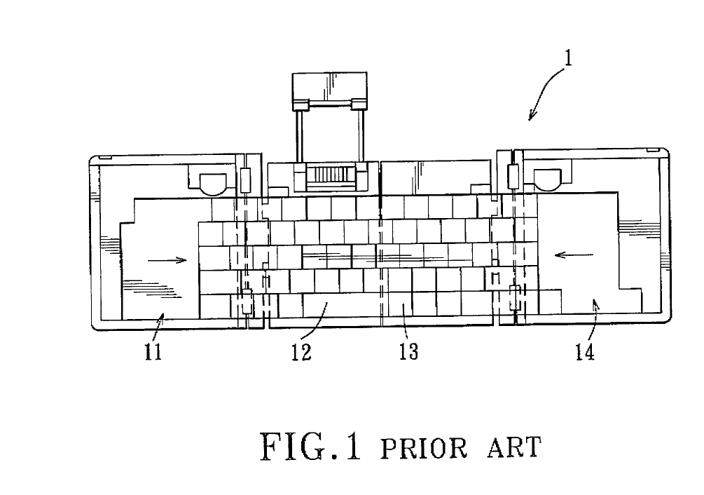

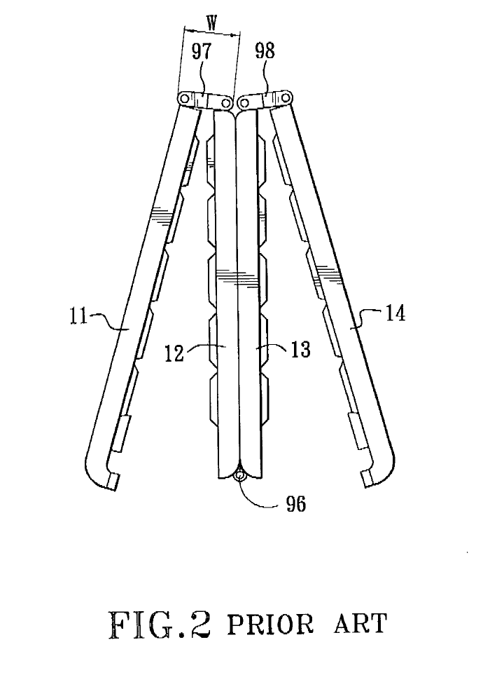

### DETAILED DESCRIPTION OF THE PREFERRED EMBODIMENTS

For the sake of brevity, like elements are denoted by the same reference numerals throughout the disclosure.

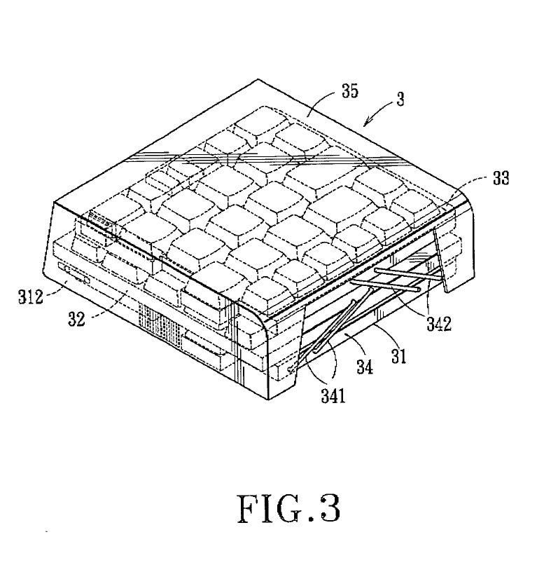

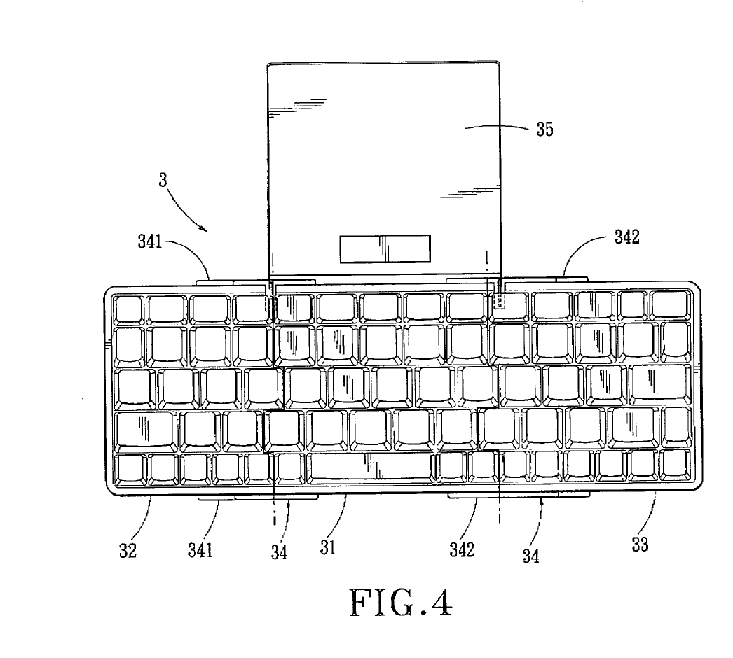

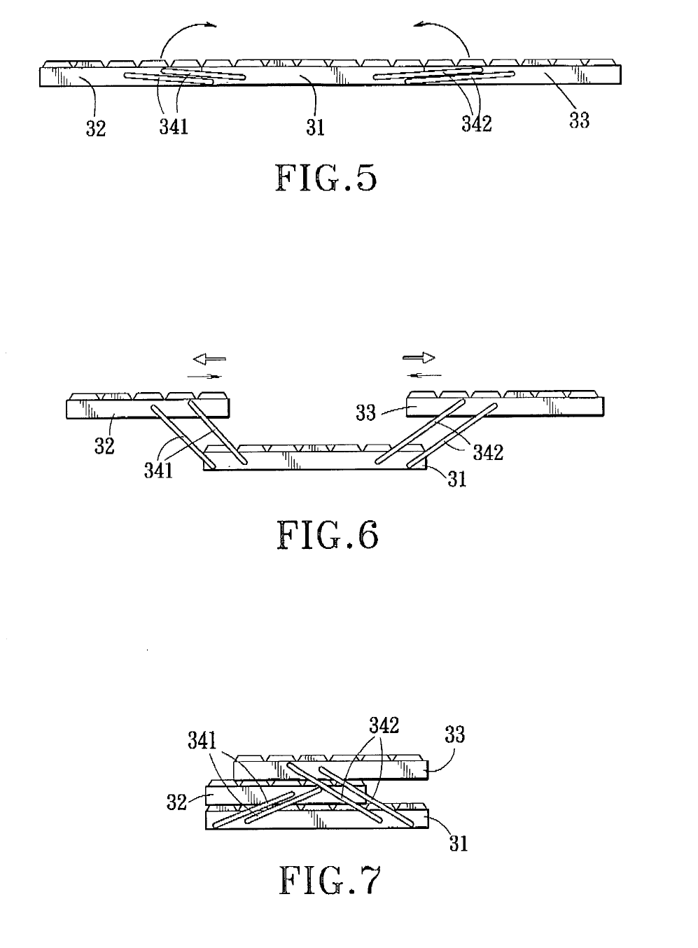

FIGS. 3 to 9 illustrate a first preferred embodiment of a foldable keyboard according to this invention. The foldable keyboard includes: a keyboard body 3 including a central section 31 with opposite left and right sides and opposite front and rear sides, and left and right sections 32, 33 respectively disposed at the left and right sides of the central section 31, each of the left and right sections 32, 33 having front and rear sides; and a linkage unit 34 including two opposing pairs of first parallel linkages 341 that are respectively pivoted to the front and rear sides of the left and central sections 32, 31 adjacent to the left side of the central section 31, and two opposing pairs of second parallel linkages 342 that are respectively pivoted to the front and rear sides of the right and central sections 33, 31 adjacent to the right side of the central section 31 so as to permit folding of the keyboard body 3 from an extended position (see FIG. 4) to a folded position (see FIG. 3). FIGS. 5 to 7 illustrate consecutive steps for moving the keyboard body 3 is moved from the extended position to the folded position.

Each of the first parallel linkages 341 has a length less than that of each of the second parallel linkages 342 such that the central, left, and right sections 31, 32 ,33 of the keyboard body 3 are stacked one above the other when the keyboard body 3 is disposed at the folded position.

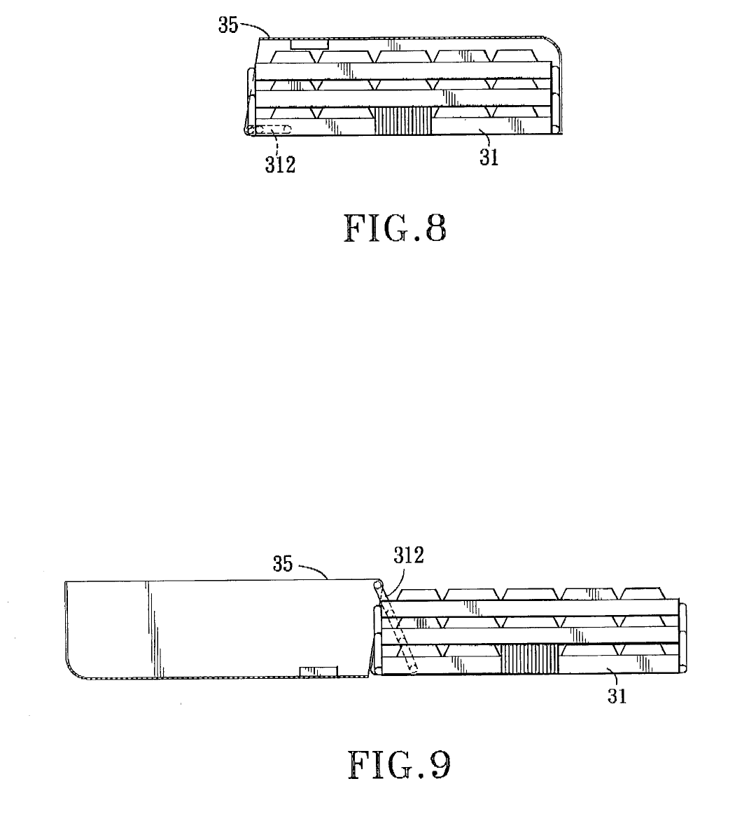

Referring now to FIGS. 8 and 9, in combination with FIG. 3, a cover 35 is pivoted to the rear side of the central section 31 via a pair of linkages 312 for covering the keyboard body 3 when the keyboard body 3 is disposed at the folded position.

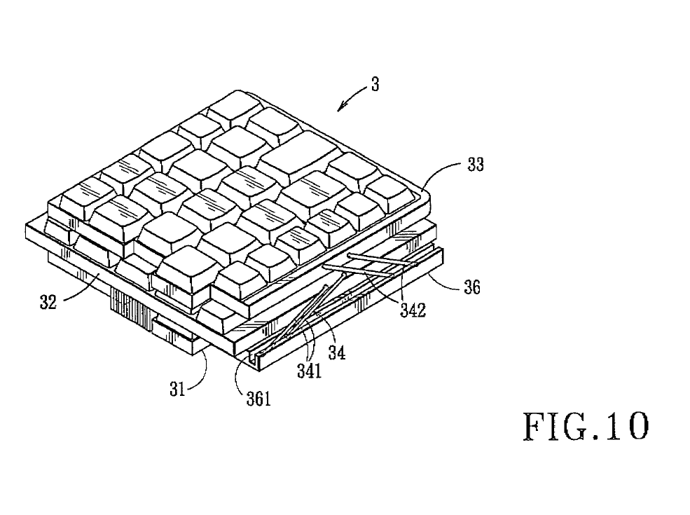

FIG. 10 illustrates a second preferred embodiment of the foldable keyboard according to this invention. The foldable keyboard of this embodiment is similar to the previous embodiment shown in FIG. 3, and is further provided with a linkage covering member 36 that projects from the front side of the central section 31 of the keyboard body 3 and that is formed with a groove 361. One of the pairs of the first parallel linkages 341 and one of the pairs of the second parallel linkages 342 have pivot ends pivoted to the linkage covering member 36 and received in the groove 361.

Due to the first and second parallel linkages 341, 342 in the foldable keyboard according to this invention, the aforesaid drawback associated with the prior art can be eliminated.

With the invention thus explained, it is apparent that various modifications can be made without departing from the spirit of the present invention. It is therefore intended that the invention be limited only as recited in the appended claims.

We claim:

1. A foldable keyboard comprising:
a keyboard body including a central section with opposite left and right sides and opposite front and rear sides, and left and right sections respectively disposed at said left and right sides of said central section, each of said left and right sections having front and rear sides; and
a linkage unit including two opposing pairs of first parallel linkages that are respectively pivoted to said front and rear sides of said left and central sections adjacent to said left side of said central section, and two opposing pairs of second parallel linkages that are respectively pivoted to said front and rear sides of said right and central sections adjacent to said right side of said central section so as to permit folding of said keyboard body.

2. The foldable keyboard of claim 1, wherein said keyboard body is foldable from an extended position to a folded position, each of said first parallel linkages having a length less than that of each of said second parallel linkages such that said central, left, and right sections of said keyboard body are stacked one above the other when said keyboard body is disposed at said folded position.

3. The foldable keyboard of claim 1, further comprising a cover pivoted to said rear side of said central section for covering said keyboard body when said keyboard body is disposed at said folded position.
